(19) United States
(12) Patent Application Publication
(10) Pub. No.: US 2007/0277894 A1
(43) Pub. Date: Dec. 6, 2007

(54) Oilfield Pipeline Crossover

(76) Inventors: Ben Boone, Nisku (CA); Reg McKinney, Nisku (CA)

Correspondence Address: Bay Area Patent Group, LLC, 13630 58TH ST. NORTH, SUITE 101, CLEARWATER, FL, 33760, US

(21) Appl. No.: 11/421,781

(22) Filed: Jun. 2, 2006

(51) Int. Cl. F16L 57/00

(52) U.S. Cl. 138/110

(57) ABSTRACT

A portable protective crossover of a high strength construction for positioning about an elevated utility line, such as an oilfield flare stack pipeline. The crossover includes a body having opposed ramp surfaces and a passage through which an elevated pipeline to be bridged by the crossover is passed through. The passage has an internal dimension which is greater than the external dimension of the pipeline. The crossover is positionable so that no portion of pipeline is placed into contact with the crossover. The crossover is constructed particularly to provide a generally clamshell type structure which encloses about the pipeline and which prevents transferring of weight of the crossover and a vehicle crossing the crossover to the pipeline. The construction allows the pipeline to move and buckle during a blowout to prevent rupture of the pipeline.

### FIELD OF THE INVENTION

The present invention relates generally to crossovers for utility lines, such as electrical lines or fluid carrying lines. More particularly, relating to a readily positionable, high strength crossover for oilfield pipelines that are supported at an elevation above a surface.

### BACKGROUND OF THE INVENTION

On oil rigs, flare stacks are used primarily as a safety device to protect vessels or pipes from over-pressuring due to unplanned upsets, such as in a blowout. A flare stack is an elevated vertical stack or chimney used for burning off gas or oil in a blowout situation. A blowout is an uncontrolled flow of reservoir fluids into the wellbore, and sometimes catastrophically to the surface and may consist of water, oil, gas or a mixture of these. For the safety of rig workers, flare stacks must be located at a great distance from the rig, and in some circumstances the flare stacks are located three hundred feet or more from the rig. A pipeline running between the rig and flare stack connects the rig to the flare stack to carry fluids to the flare stack for venting. These pipelines are required to be supported at an elevation above the ground surface to allow the pipelines to buckle or move during a high pressure blowout to prevent rupturing of the pipelines.

At an oil rig site, it is desirable to be able to travel from one side of the rig to an opposite side, for example when large trucks are transporting drill pipe to the site. Currently, in order to travel from one side of the rig to an opposite side that is separated by a flare stack pipeline, one must travel completely around the end of the pipeline and the flare stack to reach the opposite side. As such there is a need for a high strength pipeline crossover to provide for a protective bridge for crossing over the pipeline without damaging or impeding the functional operation of the pipeline.

### SUMMARY OF THE INVENTION

In accordance with the present invention, a crossover over for forming a protective bridge over oilfield flare stack pipelines that a vehicle may traverse to cross from one side of the pipelines to an opposite side is provided.

In general, in one aspect, a crossover for an oilfield pipeline that is supported at a spaced distance above a ground surface is provided. The crossover includes a body having opposed ramp surfaces forming longitudinal sides of the body and being constructed to form a protective crossover for the pipeline. The body has a bottom surface for supporting the body on a ground surface and at least one through passage extending longitudinally from end to end of the body for the passage of the pipeline. The through passage has a peripheral wall with an internal diameter greater than the external diameter of the pipeline. And the body being positionable such that the peripheral wall is free from contact with the pipeline.

In general, in another aspect, a crossover for an oilfield pipeline that is supported at a spaced distance above a ground surface is provided. The crossover includes a body having opposed ramp surfaces forming longitudinal sides of the body and being constructed to form a protective crossover for the pipeline. The body has a bottom surface for supporting the body on a ground surface and at least one through passage extending longitudinally from end to end of the body for the passage of the pipeline. The through passage has a peripheral wall with an internal diameter greater than the external diameter of the pipeline. And the body being positionable such that the peripheral wall is free from contact with the pipeline. The body is of a is of a clamshell construction and includes a base member forming a bottom portion of the body, the base member having a first channel constructed to partially define a bottom portion of the peripheral wall of the at least one through passage; and a top member forming a top portion of the body and being constructed to complement the base member, the top member having a second channel constructed to complement the first channel and to define a top portion of the peripheral wall of said at least one through passage.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof Such description makes reference to the annexed drawings wherein:

FIG. 1 is a perspective view of the pipeline crossover constructed in accordance with the principles of the present invention;

FIG. 2 is a perspective view of the of the pipeline crossover with a top member rotated opening illustrating the internal frame work of the crossover;

FIG. 3 is an end view of the pipeline crossover, illustrating the clearance between a pipeline and the crossover;

FIG. 4 is an end view of the pipeline crossover, illustrating a top member exploded from a bottom member; and

FIG. 5 is an end view of the pipeline crossover, illustrating top member hingidly attached to a bottom member and rotated into a partially open position.

The same reference numerals refer to the same parts throughout the various figures.

### DETAILED DESCRIPTION OF THE INVENTION

Referring now to the drawings, the oilfield pipeline crossover 10 of this invention has a high strength construction to provide a protective bridge for crossing over oilfield pipelines without damaging or impeding the operation of the pipelines.

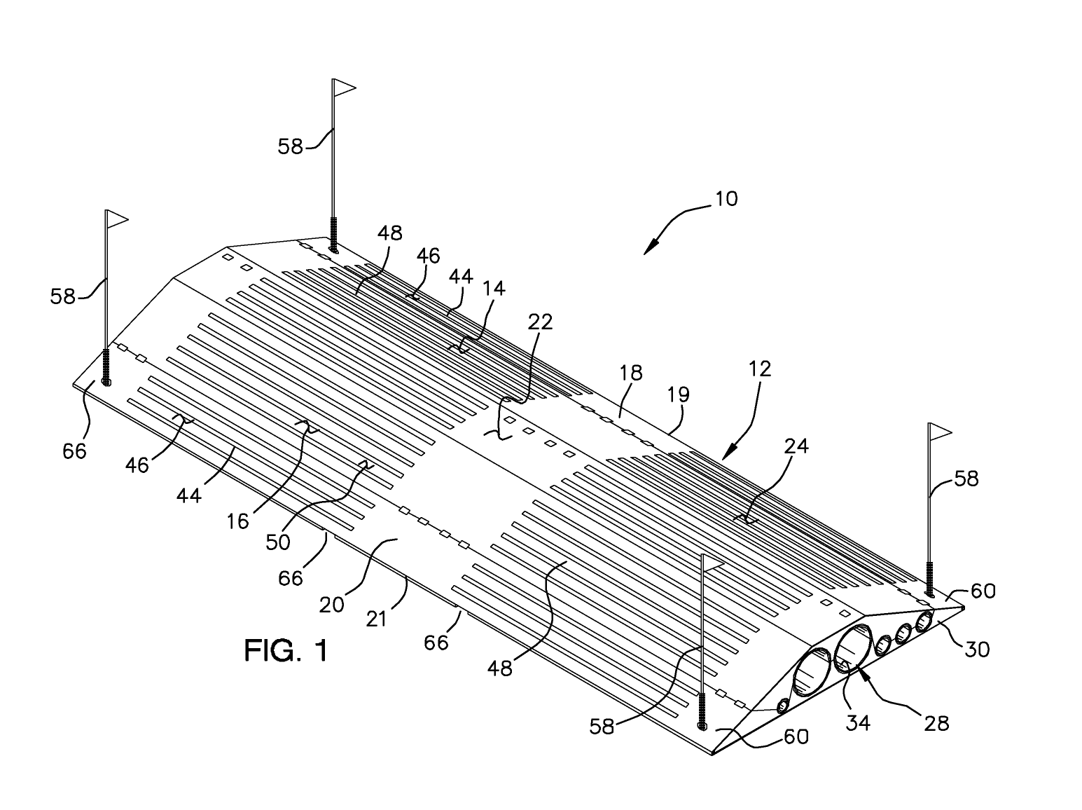

With reference now to FIG. 1, the crossover 10 includes a body 12 having opposed ramp surfaces 14 and 16 which form the longitudinal sides 18 and 20 of the body 12. Each ramp surface 14 and 16 extends from its respective outer edge 19 and 21 upwardly at an inclination to the maximum height of the body 12 and merges with a horizontal central surface 22. Each ramp surface 14 and 16 together with the central surface 22 form a top surface 24 which a vehicle may traverse to travel from one side of the crossover 10 to the opposite side. The body 12 includes a generally horizontal and continuous bottom surface 26 for placement upon a ground surface. At least one through passage 28 extends longitudinally through the body 12 from a first end 30 to a second end 32. As shown, many through passages 28 can extend longitudinally through the body 12 to accommodate several pipelines. Each passage 28 includes a peripheral wall 34 having an internal diameter or internal dimension greater than the outer diameter or outer dimension of a respective pipeline. The body 12 of the crossover 10 is positioned such that a pipeline passes through a respective passage 28, thereby providing a protective bridge for crossing over the pipeline. The body 12 is positioned such that the pipeline is free from contact with the peripheral wall 34 of the respective passage 28. The clearance between the peripheral wall 34 and the pipeline insures no load is passed onto the pipeline when a vehicle passes across the crossover 10 and insures the pipeline is free to buckle or move in the event of a higher pressure blowout to prevent rupturing of the pipeline.

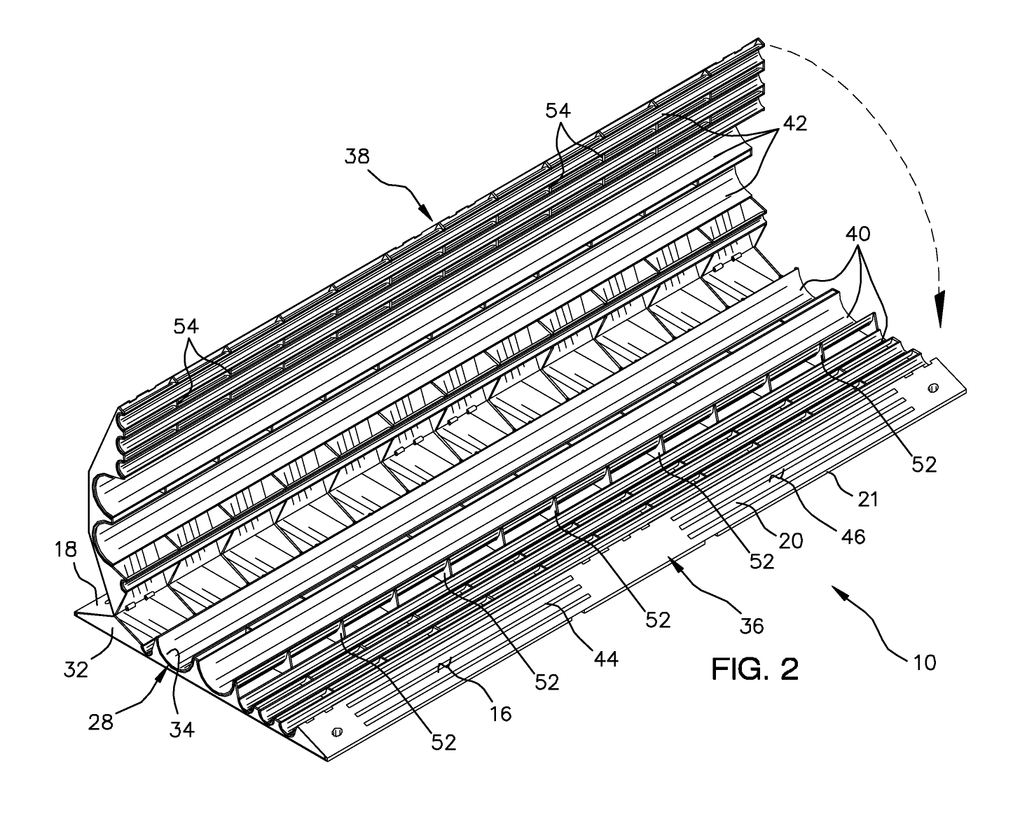

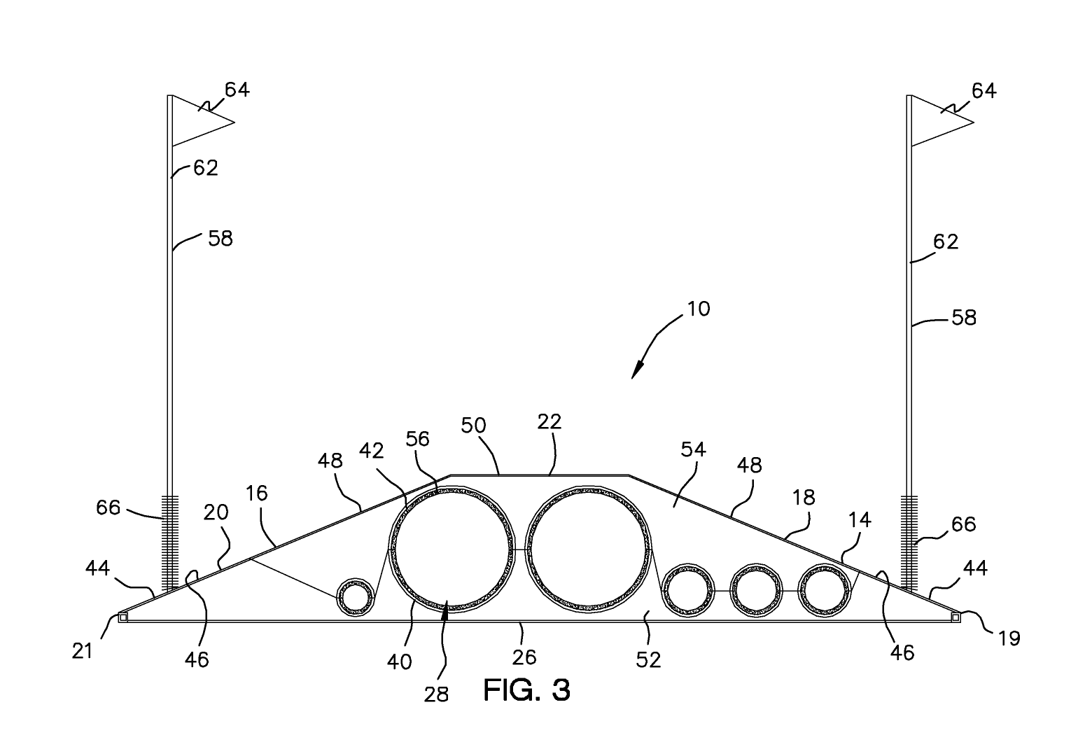

With reference to FIGS. 2 and 3, the body 12 is of a two-part, clam shell type construction including a base member 36 and a top member 38. The base member 36 forms a complete bottom portion of the body and the top member 38 forms a complete and complementary top portion of the body. The base member 36 and top member 38 can be of a unitary body construction or of a frame work construction as shown.

The base member 36 includes at least one, or as shown, a plurality of semi-circular channels 40 that form a bottom portion of each peripheral wall 34 of each passage 28 and the top member 38 includes a plurality of complementary semi-circular channels 42 which form a top portion of each peripheral wall of each passage. The top member 38 being complementary to the base member 36 is mated to complete the peripheral wall 34 of each passage 28 to enclose a pipeline within a respective passage.

With reference to FIGS. 1, 2, and 3, a bottom portion 44 of each ramp surface 14 and 16 is defined by an upper surface 46 of the base member 36 with the top portion 48 of each ramp surface 14 and 16, and the central surface 22 being defined by an upper surface 50 of the top member 38. Mating the top member 38 with the base member 36 brings together the bottom portion 44 with the top portion 48 of each ramp surface 14 and 16 to complete the top surface 24 of the crossover 10.

A plurality of gussets 52 are formed normal to the channels 40 and are spaced along the longitudinal length of the base member 36 and extend upward from the topside of the bottom surface 26. The gussets 52 support the channels 40 and add rigidity to the base member 36. A plurality of complementary gussets 54 are formed normal to channels 42 and extend downward from the underside of the top surface 24. The gussets 54 support the channels 42 and add rigidity to the top member 38. The free ends of each complementary support gusset 52 and 54 are brought together during mating of the top member 38 with the base member 36 to form a continuous gusset which provides support to the top surface 24 to bear the weight of a vehicle crossing the crossover 10.

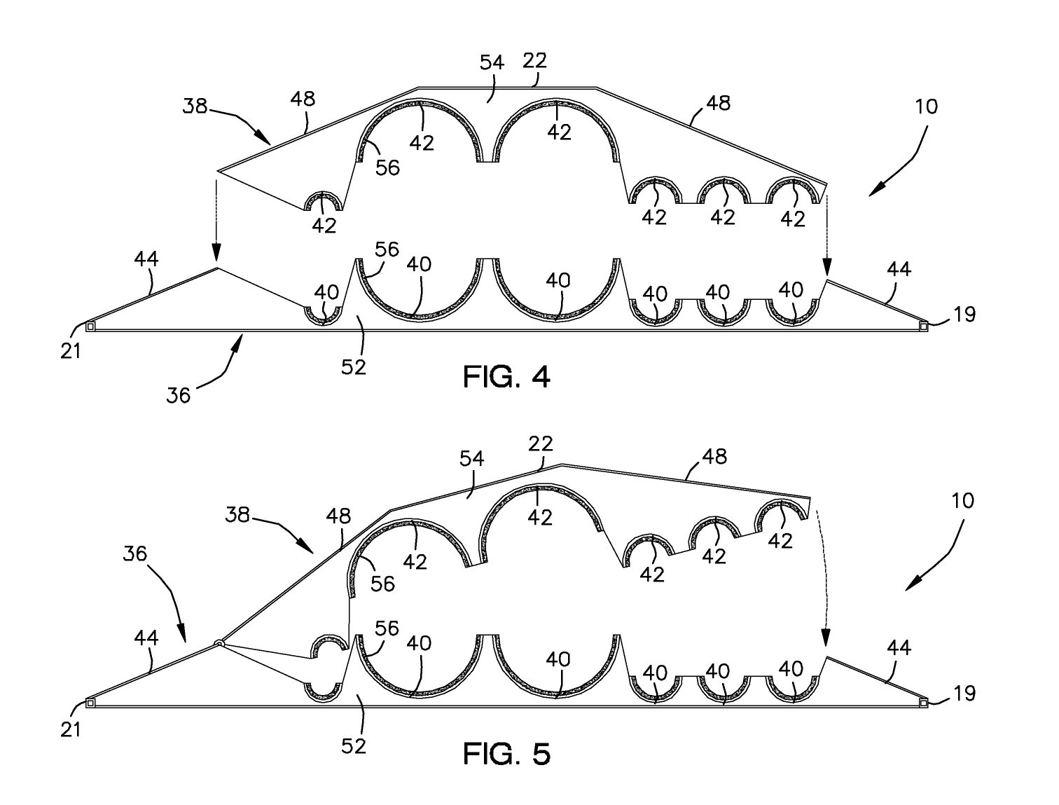

With reference to FIG. 4, the top member 38 can be separate from the base member 36 and can simply placed atop the base member to mate the two members together. The complementary construction of the top member 38 and base member 36 insures the members remain mated together. The top member 38 can be hingidly attached to the base member 36, as shown in FIGS. 2 and 5, such that the top member rotates about an axis that is parallel to the longitudinal sides 18 and 20 of the body 12.

In further embodiment, the peripheral wall 34 of each passage 28 can be coated with a protective coating 56. The protective coating 56 prevents metal to metal contact between the body 12 of the crossover 10, if constructed of a metal, and a pipeline. The protective coating 56 can be a plasticized coating.

In yet a further embodiment, the crossover 10 can include an edge marker 58 positioned at each corner 60 of the body 12, as shown in FIGS. 1, and 3. The edge marker 58 can comprise a flag staff 62 supporting a flag 64 at one end and connected at the opposite end to the body 12. The flag staff 62 can be connected to the body 12 by a spring member 66 so that the flag staff can deflect if hit by a vehicle.

In yet a further embodiment, a pair of spaced channels 66 can be formed through the body 12 normal to the longitudinal sides 18 and 20. The spaced channels 66 are for receiving the tines of a forklift to maneuver the crossover 10 into position.

A number of embodiments of the present invention have been described. Nevertheless, it will be understood that various modifications may be made without departing from the spirit and scope of the invention. Accordingly, other embodiments are within the scope of the following claims.

I claim:

1. A crossover for an oilfield pipeline that is supported at a spaced distance above a ground surface, the crossover comprising:
a body having opposed ramp surfaces forming longitudinal sides of said body and being constructed to form a protective crossover for the pipeline, said body having a bottom surface and at least one through passage extending longitudinally from end to end of said body for the passage of the pipeline, said through passage having a peripheral wall with an internal diameter greater than the external diameter of the pipeline, and said body being positionable such that said peripheral wall is free from contact with the pipeline.

2. The crossover of claim 1, wherein said body is of a clamshell construction and includes:
a base member forming a bottom portion of said body, said base member having a first channel constructed to partially define a bottom portion of said peripheral wall of said at least one through passage; and
a top member forming a top portion of said body and being constructed to complement said base member, said top member having a second channel constructed to complement said first channel and to define a top portion of said peripheral wall of said at least one through passage.

3. The crossover of claim 2, wherein said top member is hingidly attached to said base member such that said top member rotates about an axis that is parallel to said longitudinal sides of said body.

4. The crossover of claim 2, wherein said base member includes an upper surface which defines a bottom portion of each of said opposed ramp surfaces and wherein said top member includes an upper surface which defines a top portion of each of said opposed ramps surfaces.

5. The crossover of claim 1, wherein said at least one through passage is of a circular cross-section.

6. The crossover of claim 1, further comprising:
an edge marker positioned at each corner of said body.

7. The crossover of claim 1, further comprising:
a coating applied to said peripheral wall.

8. A crossover for an oilfield pipeline that is supported at a spaced distance above a ground surface, the crossover comprising:
a body having opposed ramp surfaces forming longitudinal sides of said body, each ramp surface of said opposed ramp surfaces extending from an outermost respective edge upwardly at an inclination and merging at an opposite edge with a horizontal central surface, said opposed ramps surfaces and said horizontal central surface together forming a top surface that a vehicle may traverse across, said body having bottom surface for supporting said body on a ground surface, said body having at least one through passage extending longitudinally from end to end of said body for the passage of the pipeline, said through passage having a peripheral wall with an internal diameter greater than the external diameter of the pipeline, and said body being positionable such that said peripheral wall is free from contact with the pipeline.

9. The crossover of claim 8, wherein said body is of a clamshell construction and includes:
a base member forming a bottom portion of said body, said base member having a first channel constructed to partially define a bottom portion of said peripheral wall of said at least one through passage; and
a top member forming a top portion of said body and being constructed to complement said base member, said top member having a second channel constructed to complement said first channel and to define a top portion of said peripheral wall of said at least one through passage.

10. The crossover of claim 9, further comprising:
a plurality of first gussets formed normal to said first channel and spaced longitudinally along said base member; and
a plurality of second gussets being complementary to said plurality of first gussets and being formed normal to said second channel and spaced longitudinally along said top member.

11. The crossover of claim 9, wherein said top member is hingidly attached to said base member such that said top member rotates about an axis that is parallel to said longitudinal sides of said body.

12. The crossover of claim 9, wherein said base member includes an upper surface which defines a bottom portion of each of said opposed ramp surfaces and wherein said top member includes an upper surface which defines a top portion of each of said opposed ramps surfaces.

13. The crossover of claim 8, further comprising:
an edge marker positioned at each corner of said body.

14. The crossover of claim 8, further comprising:
a coating applied to said peripheral wall.

15. A crossover for an oilfield pipeline that is supported at a spaced distance above a ground surface, the crossover comprising:
a body having opposed ramp surfaces forming longitudinal sides of said body, each ramp surface of said opposed ramp surfaces extending from an outermost respective edge upwardly at an inclination and merging at an opposite edge with a horizontal central surface, said opposed ramps surfaces and said horizontal central surface together forming a top surface that a vehicle may traverse across, said body having bottom surface for supporting said body on a ground surface, said body having at least one through passage extending longitudinally from end to end of said body for the passage of the pipeline, said through passage having a peripheral wall with an internal diameter greater than the external diameter of the pipeline, and said body being positionable such that said peripheral wall is free from contact with the pipeline;
wherein said body is of a clamshell construction and includes:
a base member forming a bottom portion of said body, said base member having a first channel constructed to partially define a bottom portion of said peripheral wall of said at least one through passage;
a top member forming a top portion of said body and being constructed to complement said base member, said top member having a second channel constructed to complement said first channel and to define a top portion of said peripheral wall of said at least one through passage; and
wherein said top member is hingidly attached to said base member such that said top member rotates about an axis that is parallel to said longitudinal sides of said body.

16. The crossover of claim 15, further comprising:
a plurality of first gussets formed normal to said first channel and spaced longitudinally along said base member; and
a plurality of second gussets being complementary to said plurality of first gussets and being formed normal to said second channel and spaced longitudinally along said top member.

17. The crossover of claim 15, wherein said base member includes an upper surface which defines a bottom portion of each of said opposed ramp surfaces and wherein said top member includes an upper surface which defines a top portion of each of said opposed ramps surfaces.

18. The crossover of claim 15, further comprising:
an edge marker positioned at each corner of said body.

19. The crossover of claim 15, further comprising:
a coating applied to said peripheral wall.
